(19) United States
(12) Patent Application Publication
(10) Pub. No.: US 2024/0396271 A1
(43) Pub. Date: Nov. 28, 2024

(54) ANTENNA DEVICE

(71) Applicant: GRAND-TEK TECHNOLOGY CO., LTD., New Taipei City (TW)

(72) Inventor: Kung-Yu SHEN, New Taipei City (TW)

(21) Appl. No.: 18/240,283

(22) Filed: Aug. 30, 2023

(30) Foreign Application Priority Data
May 24, 2023 (TW) 112205161

(51) Int. Cl. H01R 24/40; H01Q 1/08; H01R 13/52; H01R 13/627

(52) U.S. Cl. CPC H01R 24/40; H01Q 1/084; H01R 13/5202; H01R 13/6272; H01R 2103/00; H01R 2201/02

(57) ABSTRACT

An antenna device includes an antenna plug, a damper ring and an antenna body. The antenna plug includes an adaptor and a radio frequency (RF) connector. The RF connector includes a locked case, a dielectric member, and an inner conductor. The inner conductor is fixed in the dielectric member. One end of the dielectric member is rotatably disposed in the locked case, and another end of the dielectric member is fixed on the adaptor. The damper ring is disposed around the dielectric member and pre-compressedly and elastically disposed between the dielectric member and the locked case. The antenna body is pivoted to the adaptor. When the dielectric member rotates against the locked case, the damper ring exerts a reverse damping force on the dielectric member.

### BACKGROUND

### Technical Field

The disclosure relates to an antenna field, particularly to an antenna device which may be rapidly plugged and unplugged and may prevent an antenna from rotating with respect to gravity.

### Related Art

Most of the communication equipment (such as mobile phones, radios, etc.), audio-video equipment (such as TVs, radios, etc.) and network equipment (such as WIFI, etc.) need to receive or transmit signals through antenna devices to achieve the effect of signal transmission. However, in the daily life environment, there are often obstructions such as tall buildings, so most of the antennas of the antenna devices are designed to be rotatable, so as to adjust the angle of the antenna to maintain good signal reception or transmission.

In order to achieve a 360-degree adjustment effect, in addition to pivoting an antenna to an adapter, usually, an antenna adapter is directly connected to an antenna RF connector (such as an SMA connector, a TNC coaxial connector or an N-type coaxial connector, etc.). Also, it needs to be twisted with the connector on the equipment side to completely conduct the signal, and then the rotation of the RF connector itself can be used to achieve the adjustment requirements of different angles, so most of them are cumbersome and time-consuming to assemble and cannot be quickly plugged and unplugged.

In addition, as the number of antennas required for wireless communication equipment is increasing and the installation location of the equipment is also becoming more and more variable, the complexity of assembling an RF connector on the equipment is correspondingly increased, so it is necessary to quickly plug and unplug an RF connector. However, due to the weight of the antenna itself of the quick plug-in RF connector and the force arm relative to the rotation position of the RF connector, the antenna often drives the adaptor to rotate because the torque generated by gravity. As a result, the antenna cannot be effectively fixed on a desired position for receiving or transmitting signals.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY

An object of the disclosure is to be able to rapidly plug and unplug an antenna device and prevent an antenna body from rotating an adaptor with respect to gravity.

To accomplish the above object, the disclosure provides an antenna device, which includes an antenna plug, a damper ring and an antenna body. The antenna plug includes an adaptor and a radio frequency (RF) connector. The RF connector includes a locked case, a dielectric member, and an inner conductor. The inner conductor is fixed in the dielectric member. One end of the dielectric member is rotatably disposed in the locked case, and another end of the dielectric member is fixed on the adaptor. The damper ring is disposed around the dielectric member and pre-compressedly and elastically disposed between the dielectric member and the locked case.

The antenna body is pivoted to the adaptor. When the dielectric member rotates against the locked case, the damper ring exerts a reverse damping force on the dielectric member.

In an embodiment of the disclosure, the dielectric member is of a cylindrical shape and has an outer surface, the dielectric member is outward extended with a separator plate from the outer surface, and two sides of the separator plate separately abut against the locked case and the adaptor.

In an embodiment of the disclosure, a side of the separator plate, which faces the locked case, is formed with a recess, the damper ring is received in the recess and pre-compressedly and elastically disposed between the dielectric member and the locked case.

In an embodiment of the disclosure, the outer surface is formed with a trough, the damper ring is received in the trough and pre-compressedly and elastically disposed between the dielectric member and the locked case.

In an embodiment of the disclosure, the RF connector further includes a water-resistant rubber ring, the water-resistant rubber ring sheathes the dielectric member and is elastically disposed between the dielectric member and the locked case, and the damper ring is located between the separator plate and the water-resistant rubber ring.

In an embodiment of the disclosure, the RF connector further includes a water-resistant rubber ring, the water-resistant rubber ring is elastically disposed between the dielectric member and the adaptor.

In an embodiment of the disclosure, the damper ring is an O-ring.

In an embodiment of the disclosure, the damper ring is a waved spring.

In an embodiment of the disclosure, the RF connector is a female Fakra connector.

In an embodiment of the disclosure, the adaptor has a fixing hole, and an end of the dielectric member is plugged in the fixing hole.

In the antenna device of the disclosure, by the damper ring sheathing the dielectric member and being pre-compressedly and elastically disposed between the dielectric member and the locked case, when the dielectric member rotates against the locked case, the damper ring may exert a reverse damping force on the dielectric member. As a result, the antenna device may be rapidly plugged and unplugged, and the antenna body may be effectively prevented from rotating the adaptor and the dielectric member with respect to gravity, so as to guarantee the stability of the antenna device in use.

### BRIEF DESCRIPTION OF THE DRAWINGS

FIG. 1 is an exploded view of the first embodiment of the disclosure;

FIG. 2 is a perspective view of the first embodiment of the disclosure;

FIG. 3 is a cross-sectional view of the first embodiment of the disclosure;

FIG. 4 is a cross-sectional view of the second embodiment of the disclosure; and

FIG. 5 is an exploded view of the third embodiment of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

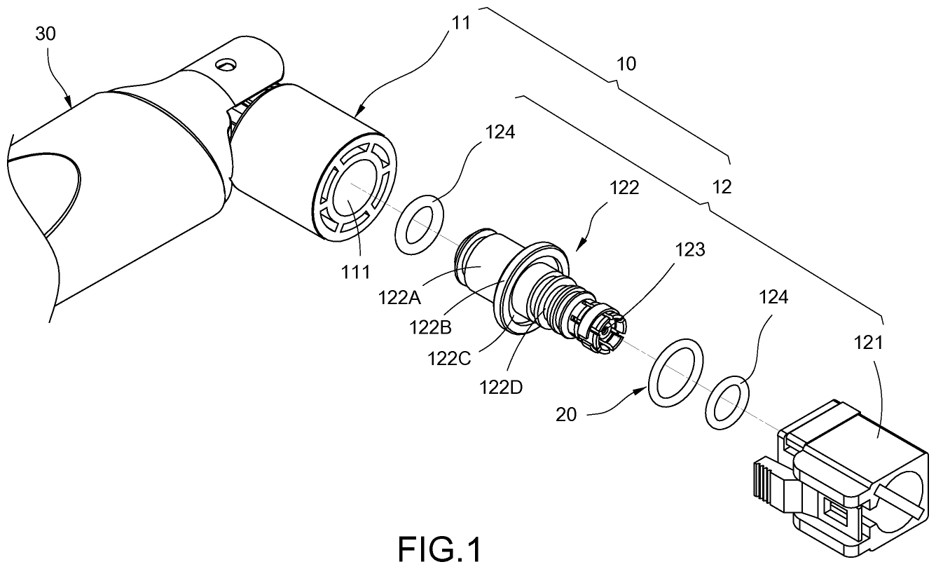

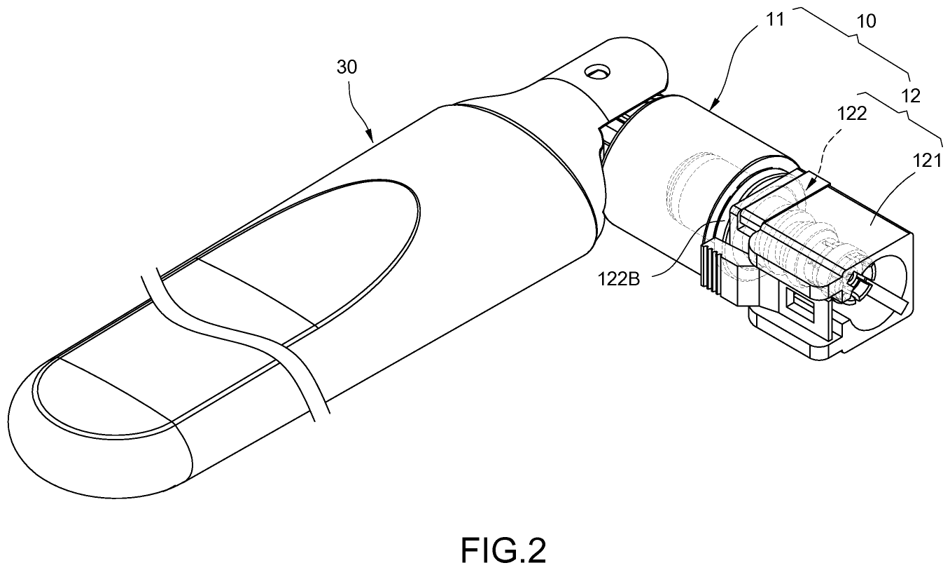

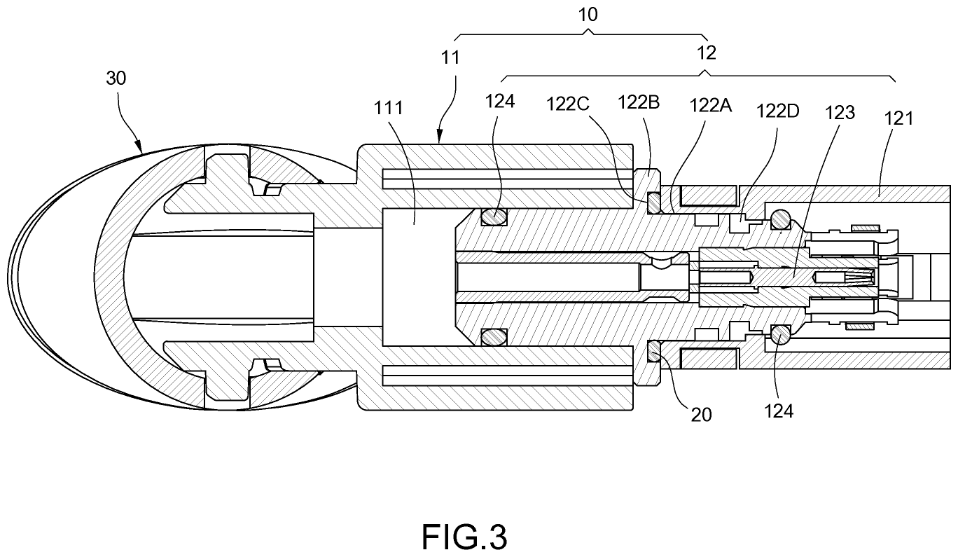

The disclosure provides an antenna device as shown in FIGS. 1-3, which includes an antenna plug 10, a damper ring 20 and an antenna body 30.

The antenna plug 10 includes an adaptor 11 and a radio frequency (RF) connector 12. The adaptor 11 of the embodiment has a fixing hole 111, but not limited to this. In the embodiment, the RF connector 12 is, but not limited to, a female Fakra connector. Any corresponding RF connector 12 belongs to the protective scope of the disclosure. The RF connector 12 includes a locked case 121, a dielectric member 122 and an inner conductor 123. The inner conductor 123 is fixed in the dielectric member 122. The inner conductor 123 is a metal material with desirable conductivity, such as copper, silver, a metal alloy, etc. The dielectric member 122 is an insulative material with a substantially cylindrical shape. One end of the dielectric member 122 is rotatably disposed in the locked case 121, and the other end of the dielectric member 122 is plugged and fixed in the fixing hole 111 of the adaptor 11. Thus, the inner conductor 123, the dielectric member 122 and the adaptor 11 may simultaneously rotate relative to the locked case 121. It is noted that the adaptor 11 may be plugged and fixed on the dielectric member 122, here is not intended to be limiting, the requirement is that the two are fixed.

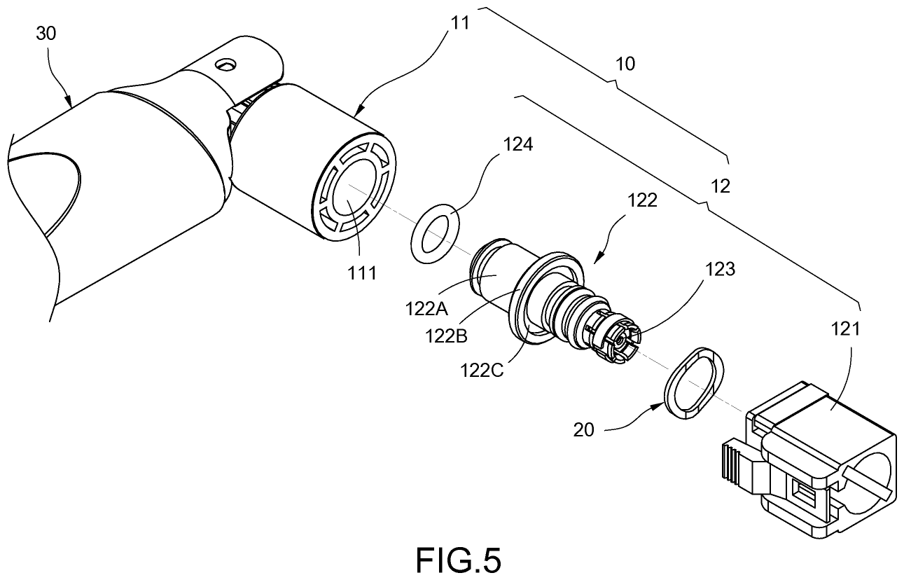

The damper ring 20 is of an annular shape. The damper ring 20 is disposed around (sheathes) the dielectric member 122 and pre-compressedly and elastically disposed between the dielectric member 122 and the locked case 121. In the embodiment, the damper ring 20 is, but not limited to, a rubber O-ring or a silicone O-ring. For example, the damper ring 20 may also be a waved spring as the third embodiment shown in FIG. 5 to achieve the same effect of damping.

The antenna body 30 is pivoted to the adaptor 11 to make the antenna body 30 be rotatable relative to the adaptor 11 within a 180-degree range, so as to cooperate with the rotation of the adaptor 11 with respect to the locked case 121 to achieve the function of 360-degree adjustment of antenna angle.

As a result, by the damper ring 20 sheathing the dielectric member 122 and being pre-compressedly and elastically disposed between the dielectric member 122 and the locked case 121, when the dielectric member 122 rotates against the locked case 121, the damper ring 20 may exert a reverse damping force on the dielectric member 122. As a result, the antenna body 30 may be effectively prevented from rotating the adaptor 11 and the dielectric member 122 with respect to gravity, so as to guarantee the stability of the antenna device in use.

In detail, please refer to FIGS. 1-3, the dielectric member 122 has an outer surface 122A. The dielectric member 122 is outward extended with a separator plate 122B from the outer surface 122A. The separator plate 122B is of a circular-plate shape. Two sides of the separator plate 122B separately abut against the locked case 121 and the adaptor 11. Also, a side of the separator plate 122B, which faces the locked case 121, is formed with a recess 122C. In the embodiment, the damper ring 20 is received in the recess 122C and pre-compressedly and elastically disposed between the separator plate 122B of the dielectric member 122 and the locked case 121, but not limited to this.

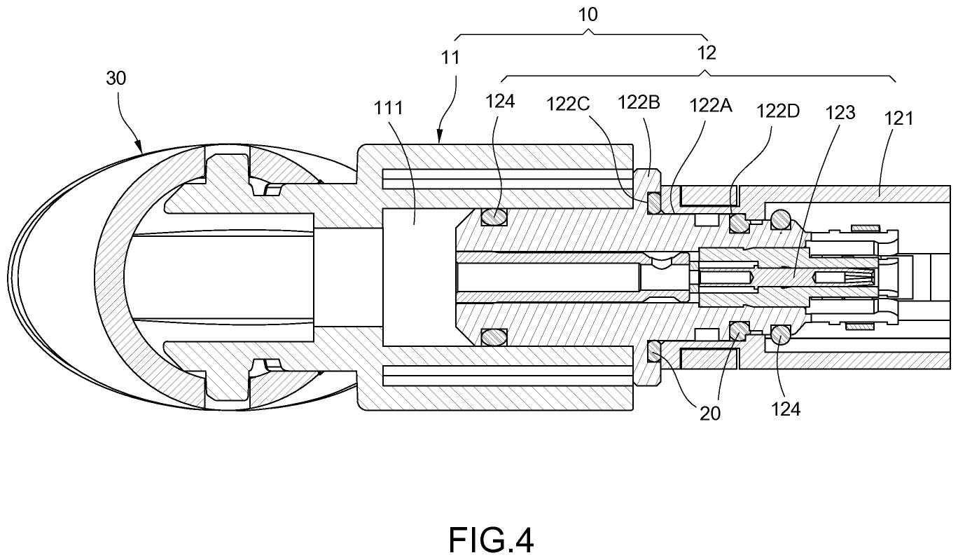

Please refer to FIG. 4, which shows the second embodiment of the disclosure. In the embodiment, the outer surface 122A of the dielectric member 122 is formed with a trough 122D. The damper ring 20 is received in the trough 122D and pre-compressedly and elastically disposed between the dielectric member 122 and the locked case 121. This may also achieve the same damping effect as the first embodiment. Also, the disclosure does not limit the number and installation position of the damper ring 20, for example, the damper ring 20 may be disposed in the recess 122C of the separator plate 122B or in the trough 122D of the dielectric member 122, or two damper rings 20 are disposed in both the recess 122C of the separator plate 122B and the trough 122D of the dielectric member 122, depending on demands in design. It is noted that when the damper ring 20 is a waved spring, it may be disposed only in the recess 122C of the separator plate 122B because a waved spring is elastically deformed toward a single direction to form a damping force, it is not capable of being disposed in the recess 122C of the separator plate 122B or the trough 122D of the dielectric member 122 as the O-ring damper ring 20.

Furthermore, the RF connector 12 of the disclosure further includes two water-resistant rubber rings 124. One of the water-resistant rubber rings 124 sheathes the dielectric member 122 and is elastically disposed between the dielectric member 122 and the locked case 121 to make the damper ring 20 be located between the separator plate 122B and the water-resistant rubber ring 124. The other water-resistant rubber ring 124 is elastically disposed between the dielectric member 122 and the adaptor 11. In detail, the dielectric member 122 of the embodiment is partially plugged and fixed in the fixing hole 111 of the adaptor 11, so the other water-resistant rubber ring 124 is disposed around part of the outer surface 122A of the dielectric member 122 which is plugged in the fixing hole 111. However, the installation position of the water-resistant rubber ring 124 should be correspondingly adjustable depending on the fixing manner between the dielectric member 122 and the adaptor 11. As a result, the RF connector 12 has a great effect of water-resistance and airtightness to provide users to use depending on different environments.

While this disclosure has been described by means of specific embodiments, numerous modifications and variations could be made thereto by those skilled in the art without departing from the scope and spirit of this disclosure set forth in the claims.

What is claimed is:

1. An antenna device comprising:
an antenna plug, comprising an adaptor and a radio frequency (RF) connector, the RF connector comprising a locked case, a dielectric member and an inner conductor, the inner conductor fixed in the dielectric member, one end of the dielectric member rotatably disposed in the locked case, and another end of the dielectric member fixed on the adaptor;
a damper ring, adapted to sheathe the dielectric member, and pre-compressedly and elastically disposed between the dielectric member and the locked case; and
an antenna body, connected pivotally with the adaptor;
wherein when the dielectric member rotates against the locked case, the damper ring exerts a reverse damping force on the dielectric member.

2. The antenna device of claim 1, wherein the dielectric member is of a cylindrical shape and comprises an outer surface, a separator plate is outward extended from the outer surface of the dielectric member, and two sides of the separator plate separately abut against the locked case and the adaptor.

3. The antenna device of claim 2, wherein a recess is defined on a side of the separator plate facing the locked case, the damper ring is received in the recess and pre-compressedly and elastically disposed between the dielectric member and the locked case.

4. The antenna device of claim 2, wherein a trough is defined on the outer surface, the damper ring is received in the trough and pre-compressedly and elastically disposed between the dielectric member and the locked case.

5. The antenna device of claim 4, wherein the RF connector further comprises a water-resistant rubber ring, the water-resistant rubber ring is adapted to sheathe the dielectric member and elastically disposed between the dielectric member and the locked case, and the damper ring is located between the separator plate and the water-resistant rubber ring.

6. The antenna device of claim 1, wherein the RF connector further comprises a water-resistant rubber ring elastically disposed between the dielectric member and the adaptor.

7. The antenna device of claim 1, wherein the damper ring is an O-ring.

8. The antenna device of claim 1, wherein the damper ring is a waved spring.

9. The antenna device of claim 1, wherein the RF connector is a female Fakra connector.

10. The antenna device of claim 1, wherein the adaptor comprises a fixing hole, and an end of the dielectric member is plugged in the fixing hole.
